(19) United States
(12) Patent Application Publication
(10) Pub. No.: US 2023/0083348 A1
(43) Pub. Date: Mar. 16, 2023

(54) COMPOSITE NONWOVEN AND PROCESS FOR PRODUCING A COMPOSITE NONWOVEN

(71) Applicant: LENZING AKTIENGESELLSCHAFT, 4860 Lenzing (AT)

(72) Inventors: Ibrahim Sagerer-Foric, 4840 Vöcklabruck (AT); Mirko Einzmann, 4600 Wels (AT); Katharina Gregorich, 4813 Altmünster (AT); Gisela Goldhalm, 3363 Neufurth (AT)

(21) Appl. No.: 17/801,607

(22) PCT Filed: Feb. 24, 2021
(86) PCT No.: PCT/EP2021/054498

§ 371 Date: Aug. 23, 2022

(30) Foreign Application Priority Data
Feb. 24, 2020 (EP) 20159094.0

(51) Int. Cl. D04H 1/56; D04H 5/03; D01D 5/098; D04H 1/425

(52) U.S. Cl. CPC D04H 1/56; D04H 5/03; D01D 5/0985; D04H 1/425

(57) ABSTRACT

A composite nonwoven fabric (1, 51, 61) and a process (100, 101, 102) for the production of the composite nonwoven fabric (1, 51, 61) are shown, wherein the composite nonwoven fabric (1, 51, 61) comprises at least one spunbonded nonwoven (8, 54, 64), which exhibits essentially continuous regenerated cellulosic filaments (4, 55, 65) deposited in a random orientation, and at least one layer (52, 62) of biobased biodegradable short fibers (14, 53, 63). So as to provide a fully biodegradable composite nonwoven fabric of the initially mentioned type, which exhibits a high stability and tensile strength as well as good absorption properties and haptic properties and, in addition, can be produced in a cost-efficient way, it is suggested that the composite nonwoven fabric (1, 51, 61) has at least one mixing area (56, 66) in which the filaments (4, 55, 65) of the spunbonded nonwoven (8, 54, 64) and the short fibers (14, 53, 63) are present in a state of physical interconnection.

### BACKGROUND OF THE INVENTION

### Field of the Invention

The present invention relates to a composite nonwoven fabric comprising at least one spunbonded nonwoven, which exhibits essentially continuous regenerated cellulosic filaments deposited in a random orientation, and a layer of biobased biodegradable short fibers.

Furthermore, the invention relates to a process for the production of a composite nonwoven fabric, wherein a cellulosic spinning mass is extruded through a plurality of nozzle holes of at least one spinneret to form filaments and the filaments are drawn, in each case, in the extrusion direction, wherein the filaments are deposited in a random orientation on a perforated conveying device to form a spunbonded nonwoven and wherein short fibers are added to the spunbonded nonwoven to form the composite nonwoven fabric.

### Prior Art

The production of spunbonded nonwovens and, respectively, nonwoven fabrics by the spunbond process, on the one hand, and by the meltblown process, on the other hand, is known from the prior art. In the spunbond process (e.g., GB 2 114 052 A or EP 3 088 585 A1), the filaments are extruded through a nozzle and pulled off and drawn by a drawing unit located underneath. By contrast, in the meltblown process (e.g., U.S. Pat. Nos. 5,080,569 A, 4,380,570 A or 5,695,377 A), the extruded filaments are entrained and drawn by hot, fast process air as soon as they exit the nozzle. In both technologies, the filaments are deposited in a random orientation on a deposit surface, for example, a perforated conveyor belt, to form a nonwoven fabric, are carried to post-processing steps and finally wound up as nonwoven rolls.

The spunbonded nonwovens produced from plastic melts according to the aforementioned processes can be produced with very low basis weights in the range of up to 10 g/m² and with high tensile strengths. However, such nonwoven fabrics generally have insufficient absorption properties for applications in which absorbency plays a role. In addition, such nonwoven fabrics are biodegradable to a small extent or not at all.

By contrast, wet-laying methods for the production of nonwoven fabrics with high absorption capacity are known from the prior art (U.S. Pat. No. 4,755,421, WO 2015/000687, U.S. Pat. No. 4,166,001), wherein a low-concentration pulp suspension is produced and applied to a conveyor belt. However, such nonwoven fabrics are afflicted with poor tensile strength and abrasion resistance. The mechanical properties of these products can, however, be improved in part by the use of synthetic binders and adhesives, which, in turn, has a negative effect on biodegradability.

A large market for nonwoven fabrics consists in applications in the area of wipes for the medical, sanitary, cosmetic, industrial or domestic sphere. However, for wipes, especially for moist wipes, high demands apply in terms of tensile strength and absorbance so that a reliable product is obtained. In order to mechanically reinforce the wet-laid nonwoven fabrics, synthetic binders and short-cut fibers based on polyethylene, polypropylene or polyester are admixed to the suspensions to be processed, as described in US 2004/0013859. Nonwoven fabrics produced by such methods exhibit poor or, respectively, incomplete biodegradability due to their content of synthetic fibers.

In order to combine the mechanical stability of synthetic spunbonded nonwovens with the absorption properties of pulp, a process has been described in EP 0 333 211 in which a synthetic meltblown nonwoven product, which, in particular, is based on polyester or polyolefin, is connected with cellulosic staple fibers or a layer of wet-laid pulp, e.g., hydrodynamically. Further developments of this process (U.S. Pat. Nos. 5,284,703, 5,587,225, US 2009/0233049) allow the production of a larger range of products, in particular the production of a cheaper mass product for the wipe market. Thus, in this process, by combining a modified airlaying process with meltblown technology, for example, an absorbent nonwoven product can be produced in which pulp fibers are present in a state of homogeneous distribution across a synthetic polyolefin fibre matrix. Such products also suffer from their incomplete biodegradability.

From today's ecological point of view, the combination of petroleum-based staple fibers as well as of petroleum-based spunbonded nonwovens, made, for example, of polyester or polypropylene, with pulp is questionable. Products specifically manufactured for the mass market, which contain petroleum-based fibers or filaments, are neither completely biodegradable, nor are there suitable recycling methods for them. Composite nonwoven fabrics made of plastic and pulp are sold worldwide and end up on landfill sites, in rivers or in the oceans after having been used a single time. Microplastics are thereby generated, which are absorbed into the food chain and whose effects on life cannot yet be fully foreseen. However, significant amounts of microplastics emerge even before, during the use of such products—as shown in abrasion tests and in the subsequent microscopic examination thereof, with clear signs of material removal and fibre breakage.

Thus, from the prior art (WO 2012/090130), methods are also known for the production of nonwoven fabrics without plastic content and without chemical binders. A layer of wet-laid pulp is thereby connected with a second nonwoven fabric layer of regenerated cellulose fibers or cellulose filaments by means of hydroentanglement. However, the process described is very complex due to the process management, since the rolls of spunbonded nonwoven have to be unwound and guided over deflections to the wet-laid pulp layer that has already been produced. It is pointed out that the cellulosic spunbonded nonwoven can also be produced continuously as with conventional spunbond processes and can be connected with the wet-laid pulp layer via pulleys and can be solidified hydraulically, it is not described, however, how the production of the cellulosic spunbonded nonwoven layer should be carried out and how a device for this purpose should look like. What is also not addressed is the material and bond density of the spunbonded nonwoven component, which is expressly described in the previously cited prior art (EP 0 333 211, U.S. Pat. Nos. 5,284,703, and 5,587,225) and depicted as critical to success and whose incorrect adjustment leads to insufficient infiltration or, respectively, weak anchoring of the pulp fibers in the produced spunbonded nonwoven and thus to a poor cohesion of layers.

Another manufacturing process in which a plastic-based spunbond process is combined directly with a wet-laying method is known from U.S. Pat. No. 7,432,219. However, this is also a non-biodegradable and therefore unsustainable solution.

Furthermore, it is known from U.S. Pat. No. 4,523,350 that cellulosic staple fibers can be processed into a fibrous web by means of a carding machine and into a nonwoven fabric with a solidification plant. Because of lower production speeds, such processes and, respectively, systems are, however, clearly inferior to spunbond and wet-laying systems in terms of production capacities. Cellulosic staple fibers are dried and pressed into bales already in the course of their production, are opened mechanically in the subsequent production of the nonwoven, are wetted again by hydroentanglement and, subsequently, are dried again as a nonwoven. Such a process must be scrutinized from the perspective of global energy conservation. In order to reduce raw material costs and drying costs and, thus, be able to produce competitive nonwoven fabric products for the mass market, such as baby or sanitary wipes, carded nonwovens are usually made from a mixture of polyester and viscose fibers and, in turn, contribute to the global problem of microplastics due to their lack of biodegradability because of the proportion of petroleum-based fibers.

It is also known from the prior art to produce cellulosic spunbonded nonwovens according to the spunbond technology (e.g., U.S. Pat. No. 8,366,988 A) and according to the meltblown technology (e.g., U.S. Pat. Nos. 6,358,461 A and 6,306,334 A). A lyocell spinning mass is thereby extruded and drawn in accordance with the known spundbond or meltblown processes. However, prior to the deposition into a nonwoven, the filaments are additionally brought into contact with a coagulant in order to regenerate the cellulose and produce dimensionally stable filaments. The wet filaments are finally deposited in a random orientation as a nonwoven fabric. However, those processes have only little in common with the thermoplastic spunbond manufacture according to the classic spunbond or meltblown processes, as initially described. Since the lyocell spinning mass is a solution with a cellulose content of 7-14%, besides the fibre-forming cellulose, far more solvent is also extruded during the spunbond manufacture, which is extracted from the nonwoven and recovered in a subsequent washing. Because of the greatly reduced solids content, the specific consumptions of compressed air of all lyocell-based spunbond processes are significantly higher than in spunbond processes based on thermoplastic melts: In order to achieve a productivity comparable to that of the thermoplastic spunbond process, in case of lyocell spunbonded nonwovens, significantly larger mass flows have to be moved and processed into a spunbonded nonwoven with more air and energy. Because of the increased energy consumption, the use of such products is indeed appropriate, thanks to their very fine fibre diameter, for special applications in the fields of filtration, sanitation or also for high-priced wipes, but the need for a cheap, purely cellulosic and biodegradable nonwoven fabric for mass markets such as, for example, baby wipes, household wipes, sanitary and industrial applications can hardly be satisfied therewith.

The prior art thus fails to offer a satisfactory solution in order to be able to produce a biodegradable, inexpensive nonwoven fabric with good tensile strengths, absorption and cleaning properties as well as a feel that is adapted to the intended use.

### SUMMARY OF THE INVENTION

Therefore, it is the object of the present invention to provide a fully biodegradable composite nonwoven fabric of the initially mentioned type, which exhibits a high stability and tensile strength as well as good absorption properties and haptic properties and, in addition, can be produced in a cost-efficient way.

The invention achieves the object that is posed in that the composite nonwoven fabric has at least one mixing area in which the filaments of the spunbonded nonwoven and the short fibers are present in a state of physical interconnection.

It has surprisingly become apparent that a particularly reliable and permanent connection between the spunbonded nonwoven and the short fibers can be created by providing a mixing area in the composite nonwoven fabric. In particular, this is true even if no additional binders are used for the connection between the filaments of the spunbonded nonwoven and the short fibers. In the mixing area, the filaments of the spunbonded nonwoven and the short fibers are present in a state of physical mixing and can thus be physically connected to each other in particular without the presence of a binder. The physical connection between the filaments of the spunbonded nonwoven and the short fibers can be formed at least partially via hydrogen bonds, mechanical interlocking or looping, frictional forces or the like. Thus, a bonded connection may form between the spunbonded nonwoven and the short fibers, which, in particular, cannot be released in a non-destructive way.

The physical mixing between the spunbonded nonwoven and the short fibers may occur, for example, by charging the spunbonded nonwoven with a suspension of the short fibers in the never-dried state, whereby a mutual penetration of the filaments of the spunbonded nonwoven and the short fibers is enabled and, thus, the mixing area is created.

The composite nonwoven fabric according to the invention is thus a purely biobased and completely biodegradable nonwoven fabric. The invention can thus contribute to the prevention of environmental pollution. In addition, the composite nonwoven fabric has high strength values due to the physical mixing or, respectively, connection between the spunbonded nonwoven and the short fibers, since the spunbonded nonwoven—with usually very high strength values —stabilizes the layer of short fibers. Moreover, such a stabilization can surprisingly take place without adversely affecting the feel of the composite nonwoven fabric. While composite nonwoven fabrics comprising binders usually display high stiffness, a composite nonwoven fabric that is softer and more flexible in comparison to the prior art can be obtained with the composite nonwoven fabric according to the invention. Moreover, the purely biobased and completely biodegradable composite nonwoven fabric exhibits a high absorption capacity and can be produced in a resource-saving manner.

Within the meaning of the present invention, natural fibers and biobased synthetic fibers produced on the basis of renewable raw materials are referred to as biobased fibers. Only biodegradable synthetic fibers which have no biogenic origin and can be produced from petroleum-based raw materials have to be distinguished therefrom. The term “bio-based fibers” in the context of this invention excludes particularly the presence of petroleum-based components in those fibers.

In case of synthetic fibers, biodegradable fibers in the context of this invention are understood to be fibers which are regarded as fully compostable in accordance with the guidelines for biodegradable plastics in the European standard EN 13432.

If the short fibers are cellulosic short fibers, the composite nonwoven fabric according to the invention may have a cellulose content of at least 93 wt.-% in the absolutely dry (“atro”) state, i.e., free from water, depending on the cellulosic short fibre that is used. Substances naturally occurring in pulps, such as lignins, as well as unavoidable impurities may, in this case, form the residual content. Such a composite nonwoven fabric displays a very good and complete biodegradability. The absolutely dry composite nonwoven fabric can preferably have a cellulose content of at least 95 wt.-%, particularly preferably of at least 97 wt.-%.

Advantageously, the composite nonwoven fabric may comprise between 10 wt.-% and 99 wt.-% of cellulosic filaments of the spunbonded nonwoven and between 1 wt.-% and 90 wt.-% of short fibers. Thanks to the composition according to the invention, a composite nonwoven fabric with proper cohesion between filaments and short fibers or, respectively, high strength can, in particular, be ensured. In this case, the composite nonwoven fabric preferably has between 15 wt.-% and 95 wt.-%, particularly preferably between 20 wt.-% and 90 wt.-%, of cellulosic filaments and between 5 wt.-% and 85 wt.-%, particularly preferably between 10 wt.-% and 80 wt.-%, of short fibers.

A composite nonwoven fabric with a particularly advantageous feel, high softness and flexibility can be provided if the composite nonwoven fabric is essentially free from binders that do not occur naturally in wood and, in particular, are synthetic. Such binder-free composite nonwoven fabrics according to the invention may be particularly suitable for a variety of applications, such as, for example, skin-friendly sanitary products. By contrast, composite nonwoven fabrics comprising binders may exhibit a very high stiffness and low softness, whereby the range of applications for such products is limited.

For the composite nonwoven fabric according to the invention, all types of cellulosic short cut fibers, such as, for example, natural cellulose fibers, viscose, modal, lyocell or cupro fibers, as well as chemically modified cellulose fibers may be used as biobased biodegradable short fibers. Furthermore, all types of fibers made of wood-containing pulps, such as mechanically digested pulps or, respectively, wood pulp, e.g., MP (mechanical pulp), TMP (thermo-mechanical pulp), CTMP (chemo-thermo-mechanical pulp) etc., are suited as short fibers. In addition, the short fibers may consist of all types of fibers of wood-free pulps, such as chemically digested pulps CP (chemical pulp), according to the sulfite, the sulfate or another process. Furthermore, all types of pulps obtained from wood or other plants, such as, e.g., from grasses, bamboo, algae, cotton or, respectively, cotton linters, hemp, flax, starch-based fibers, etc., are also possible as short fibers. In addition, all types of pulps produced from recycled textiles or nonwovens or, respectively, recycled cellulosic fibers may also be used as short fibers.

Alternatively, starch fibers are similarly suitable as biobased biodegradable short fibers for the composite nonwoven fabric according to the invention.

A particularly homogeneous composite nonwoven fabric can be created if the short fibers have a length of between 0.5 mm and 15 mm. Shorter fibers can no longer be kept reliably in the composite nonwoven fabric, while longer fibers may lead to inhomogeneous products. The length of the short fibers is particularly preferably between 1 and 12 mm.

In addition, the composite nonwoven fabric may comprise non-fibrous functional additives such as, for example, activated carbon, superabsorbent polymers, particulate dyes and fillers (clays, ground nonwoven or wood waste), etc. As a result, the composite nonwoven fabric can be provided with certain additional properties, for example, a high water absorption capacity, etc.

Moreover, before or after drying, the nonwoven fabric can be provided with auxiliary agents which change the properties of the product or facilitate processing, such as finishing agents or antistatic agents, etc.

The nonwoven fabric according to the invention is obtainable in particular by a process according to any of claims 8 to 17. If the nonwoven fabric is produced by a process of the invention according to any of claims 8 to 17, the special properties of the nonwoven fabric result from the process stage as illustrated below.

It is furthermore an object of the invention to provide a simple and reliable process of the initially mentioned type for the production of a composite nonwoven fabric according to any of claims 1 to 7.

With regard to the process, the object is achieved in that the filaments of the spunbonded nonwoven are charged with the short fibers in the never-dried state.

In the process, a cellulosic spinning mass is extruded through a plurality of nozzle holes of at least one spinneret to form filaments and the filaments are drawn, in each case, in the extrusion direction, wherein the filaments are deposited in a random orientation on a perforated conveying device to form a spunbonded nonwoven. To form the composite nonwoven fabric, short fibers are added to the spunbonded nonwoven in a further step.

Surprisingly, it has been shown that a composite nonwoven fabric according to the invention can be created with a mixing area between the filaments of the spunbonded nonwoven and the short fibers if the spunbonded nonwoven is charged with the short fibers in the never-dried state, i.e., while the filaments of the spunbonded nonwoven are still strongly swelled. Due to the softness and deformability of the never-dried spunbonded nonwoven and because of the weak bonds between the filaments therein, a mutual penetration of the filaments of the spunbonded nonwoven and the short fibers may happen so that the mixing area is created in the composite nonwoven fabric. In a subsequent drying process, hydrogen bonds may form between the filaments of the spunbonded nonwoven and the short fibers, which ensure the strong cohesion and the high strength of the composite nonwoven fabric, which, on the contrary, would not be possible with composite nonwoven fabrics made of thermoplastic nonwovens and pulp fibers (as described, for example, in WO 2012/090130).

According to this process, a fully biodegradable composite nonwoven fabric with basis weights of above 10 g/m² can thus be obtained. Depending on the positioning of the supply of the short fibers as well as on the parameters of a hydroentanglement that, possibly, has been provided additionally, composite nonwoven fabrics can be obtained in which either the process-related layer structure is still identifiable or the added short fibers are present in a state of homogeneous distribution across the thickness of the composite nonwoven fabric.

A particularly simple and reliable process for the production of the composite nonwoven fabric can be provided if the filaments of the spunbonded nonwoven are charged with a suspension of the short fibers in the never-dried state. In this case, the short fibers can simply be suspended in an aqueous transport medium, in particular an aqueous solution or, respectively, water, and can thus be applied to the formed spunbonded nonwoven in a technically simple manner.

In doing so, the suspension preferably comprises between 0.01 wt.-% and 2.00 wt.-% of short fibers. In this way, the occurrence of transport problems related to the suspension, in particular due to lines or nozzles that are clogged, can be prevented. In addition, it has become apparent that charging the spunbonded nonwoven with such a small amount of short fibers is sufficient for guaranteeing the desired loading of the spunbonded nonwoven with a defined amount of short fibers. The reliability of the process can thus be increased further.

Advantageously, the filaments of the spunbonded nonwoven can be charged with the suspension of short fibers during a washing. For example, the short fibers can be suspended directly in the washing solution or, respectively, the wash water, or the suspension can be used as a washing solution for the washing, whereby the charging of the spunbonded nonwoven with the short fibers can be integrated into a conventional spunbond washing system. A particularly economical process can thus be provided.

As an alternative or in addition to the above-described washing, the filaments of the spunbonded nonwoven can be charged with the suspension also during the formation of the spunbonded nonwoven. For example, the suspension can thus be applied directly to the freshly formed spunbonded nonwoven or, respectively, to the freshly extruded filaments.

A particularly simple and versatile process for the production of the composite nonwoven fabric can be provided if the filaments of the spunbonded nonwoven are charged with an air stream comprising the short fibers in the never-dried state. On the one hand, by providing an air stream, a simple homogeneous distribution of the short fibers may occur. On the other hand, an air stream containing the short fibers can be reliably introduced at many points in the process, allowing a particularly simple handling.

After they have been extruded from the spinneret, the filaments can thus be charged with a drawing air stream for drawing. In doing so, the short fibers can simply be added to the drawing air stream in order to thus charge the filaments of the not yet dried spunbonded nonwoven with the short fibers. The process can thus be implemented in a technically simple manner without expensive modifications to an existing plant for the production of cellulosic spunbonded nonwoven.

After the filaments have been charged with the short fibers, the composite nonwoven fabric can be subjected to at least one further treatment step. In doing so, the composite nonwoven fabric can, for example, be subjected to washing in order to wash out solvents from the cellulosic spunbonded nonwoven.

Furthermore, in one treatment step, the composite nonwoven fabric can be subjected to hydroentanglement, wherein it is additionally solidified by (high pressure) water jets. In addition, the hydroentanglement may help to increase the physical mixing between the filaments of the composite nonwoven fabric and the short fibers in the mixing area, thus improving the integrity of the composite nonwoven fabric.

In one treatment step, the composite nonwoven fabric may furthermore be subjected to water jet embossing (hydro embossing) or water jet perforation. Patterns, three-dimensional structures and perforations can thereby be introduced into the composite nonwoven fabric.

In a further treatment step, the composite nonwoven fabric may also be subjected to drying following a washing or hydroentanglement in order to remove residual moisture from the composite nonwoven fabric.

In an optional treatment step, the composite nonwoven fabric may also be subjected to a crepe process, whereby the composite nonwoven fabric is provided with a crepe structure.

A reliable process for the production of a multi-layered composite nonwoven fabric can be created if the cellulosic spinning mass is extruded through a plurality of nozzle holes of at least one second spinneret to form filaments and the filaments are drawn, in each case, in the extrusion direction, wherein the filaments of the second spinneret are deposited on the conveying device in a random orientation over the spunbonded nonwoven charged with the short fibers to form a second spunbonded nonwoven in the composite nonwoven fabric. Thus, a second cellulosic spunbonded nonwoven can be deposited over the first spunbonded nonwoven, which has already been formed and has already been provided with the short fibers, forming a mixing area therewith.

In doing so, the second cellulosic spunbonded nonwoven can preferably be applied directly to the layer of short fibers and, in turn, can thus form a purely physical connection therewith. The second cellulosic spunbonded nonwoven may preferably have different internal and structural properties than the first spunbonded nonwoven, i.e., in particular a different basis weight, a different air permeability, different filament diameters, etc.

A second layer of short fibers can, in turn, be applied to the second cellulosic spunbonded nonwoven in the never-dried state, which layer forms a second mixing area with the second spunbonded nonwoven, in which the filaments of the second spunbonded nonwoven are physically mixed with the short fibers of the second layer. For this purpose, reference is made to the above description. The short fibers of the second layer can also differ from the short fibers of the first layer in order to thus be able to produce a composite nonwoven fabric with a particularly versatile range of use.

Similarly as described above for the second spunbonded nonwoven and the second layer of short fibers, third and further cellulosic spunbonded nonwovens or, respectively, layers of short fibers may also be applied to the composite nonwoven fabric that has already been formed.

The process according to the invention can be used particularly advantageously for the production of a composite nonwoven fabric with a cellulosic spunbonded nonwoven made of a lyocell spinning mass. In this case, a lyocell spinning mass is a solution of cellulose in a direct solvent.

The direct solvent can preferably be a tertiary amine oxide, preferably N-methylmorpholine-N-oxide (NMMO) in aqueous solution or an ionic liquid in which cellulose can be dissolved without chemical derivatisation.

In this case, the content of cellulose in the spinning mass may range between 4% and 17%, preferably between 5% and 15%, particularly preferably between 6% and 14%.

In addition, the internal structure of the spunbonded nonwoven can be reliably controlled if the filaments extruded from the spinneret are coagulated at least partly. For this purpose, the filaments can preferably be charged with an aqueous coagulation liquid, which preferably is applied to the filaments in the form of a liquid, gas, mist, vapour, etc.

If NMMO is used as the direct solvent in the lyocell spinning mass, the coagulation liquid may be a mixture of demineralized water and 0 wt.-% to 40 wt.-% of NMMO, preferably 10 wt.-% to 30 wt.-% of NMMO, particularly preferably 15 wt.-% to 25 wt.-% of NMMO. A particularly reliable coagulation of the extruded filaments can thereby be achieved.

The process according to the invention can be implemented by a device for the production of a composite nonwoven fabric, the device comprising: a spinning mass production for the production of a cellulosic spinning mass, at least one spunbond plant for the production of the cellulosic spunbonded nonwoven from the spinning mass, the spunbond plant comprising at least one spinneret for the extrusion of the spinning mass into filaments, at least one coagulation system for the at least partial coagulation of the filaments and a conveying device for depositing the filaments and forming the spunbonded nonwoven, a washing, optionally hydroentanglement, a dryer, optionally a crepe device and a winder. Furthermore, the device comprises, according to the invention, a wet-laying device or a dry-laying device for charging the cellulosic spunbonded nonwoven with short fibers, the wet-laying device or, respectively, the dry-laying device for the short fibers being provided between two spunbond plants and/or before, within and/or at the end of the washing.

### BRIEF DESCRIPTION OF THE DRAWINGS

In the following, preferred embodiments of the invention are illustrated in further detail with reference to the drawings.

FIG. 1 shows a schematic illustration of the process according to the invention for the production of a composite nonwoven fabric according to a first embodiment variant,

FIG. 2 shows a schematic illustration of the process according to the invention for the production of a composite nonwoven fabric according to a second embodiment variant,

FIG. 3 shows a schematic illustration of the process according to the invention for the production of a composite nonwoven fabric according to a third embodiment variant,

FIG. 4 shows an electron microscope image of a first composite nonwoven fabric according to the invention, and

FIG. 5 shows an electron microscope image of a second composite nonwoven fabric according to the invention.

### DETAILED DESCRIPTION OF THE INVENTION

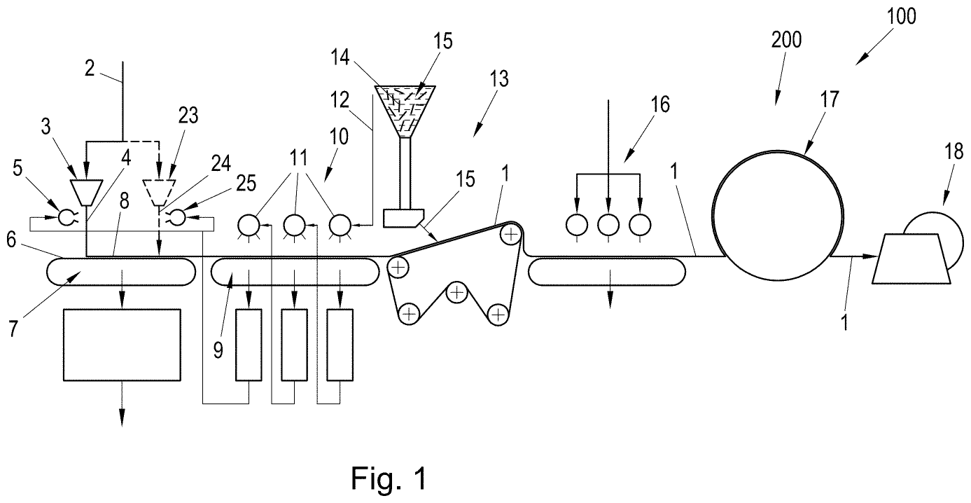

FIG. 1 shows a process 100 according to the invention for the production of a composite nonwoven fabric 1 and a device 200 for performing the process 100 according to a first embodiment variant of the invention. In a first process step, a spinning mass 2 is produced from a cellulosic raw material and supplied to a spinneret 3 of the device 200. In this case, the cellulosic raw material for producing the spinning mass 2, which is not shown in further detail in the figures, can be a pulp made of wood or other plant-based starting materials, which is suitable for the production of lyocell fibers. However, it is also conceivable that the cellulosic raw material consists at least partly of production waste from the production of spunbonded nonwoven or recycled textiles. In this case, the spinning mass 2 is a solution of cellulose in NMMO and water, with the cellulose content in the spinning mass 2 ranging between 3 wt.-% and 17 wt.-%.

In a following step, the spinning mass 2 is then extruded through a plurality of nozzle holes in the spinneret 3 to form filaments 4. The extruded filaments 4 are then accelerated and drawn in the extrusion direction in a drawing air stream, which, however, has not been illustrated in further detail in the figures.

In one embodiment variant, the drawing air stream can emerge between the nozzle holes of the spinneret 3. In a further embodiment variant, the drawing air stream may alternatively emerge around the nozzle holes. However, this is not illustrated in further detail in the figures. Such spinnerets 3 comprising drawing devices for generating a drawing air stream are known from the prior art (U.S. Pat. Nos. 3,825,380 A, 4,380,570 A, and WO 2019/068764 A1).

In the preferred embodiment that has been shown, the extruded and drawn filaments 4 are furthermore charged with a coagulant from a coagulation device 5. Said coagulant is usually water or an aqueous solution in the form of a liquid, mist or vapour. Due to the contact of the filaments 4 with the coagulant, the filaments 4 are coagulated or, respectively, regenerated at least partly, which, in particular, reduces adhesions between the individual extruded filaments 4.

The drawn and at least partially coagulated filaments 4 are then deposited in a random orientation on the tray 6 of a conveying device 7 in order to form a cellulosic spunbonded nonwoven 8.

After the formation, the spunbonded nonwoven 8 is passed across the conveyor belt 9 through a washing 10 in which the spunbonded nonwoven 8 is washed in order to free it from residues of the solvent, namely the NMMO contained in the spinning mass 2. In a preferred embodiment variant, the washing 10 is a multi-stage countercurrent washing with several washing stages 11, wherein fresh washing solution 12 is supplied to the final stage and the increasingly spent washing solution of a washing stage 11 is passed on to the respective preceding washing stage 11.

Upon washing 10, the spunbonded nonwoven 8 is guided through a wet-laying device 13 in which the never-dried spunbonded nonwoven 8 is charged with cellulosic short fibers 14, the short fibers 14 being present in a suspension 15 and the suspension 15 being applied to or, respectively, sprayed onto the spunbonded nonwoven 8. In this case, the suspension 15 has a content of short fibers 14 of between 0.01 and 2.00 wt.-%. By providing a separate wet-laying device 13 in the process 100 or, respectively, the device 200, an operation of the supply of short fibers that is independent from the surrounding production of spunbonded nonwoven can be ensured.

During the application of the suspension 15 containing the short fibers 14 to the never-dried spunbonded nonwoven 8, a layer of short fibers 14 is formed over the spunbonded nonwoven 8, and the composite nonwoven fabric 1 is thereby formed. In addition, a mixing area forms in the composite nonwoven fabric, in which the filaments of the spunbonded nonwoven 8 and the short fibers 14 are present in a state of mere physical mixing and therefore stick together without a chemical bond.

After the wet-laying device 13, the composite nonwoven fabric 1 is then subjected to hydroentanglement 16 in a following step. In the course of this hydroentanglement 16, a further bonding of the spunbonded nonwoven 8 with the layer of short fibers 14 takes place, wherein the physical connections between the filaments of the spunbonded nonwoven 8 and the short fibers 14 are enhanced further by mixing, in particular by interlocking, looping, static friction, etc.

In order to finally remove the remaining moisture from the composite nonwoven fabric 1 and to obtain a composite nonwoven fabric 1 ready for packaging, the composite nonwoven fabric 1 is subjected to drying 17 following the hydroentanglement 16.

Finally, the process 200 is concluded by optionally winding 18 and/or packaging the finished composite nonwoven fabric 1.

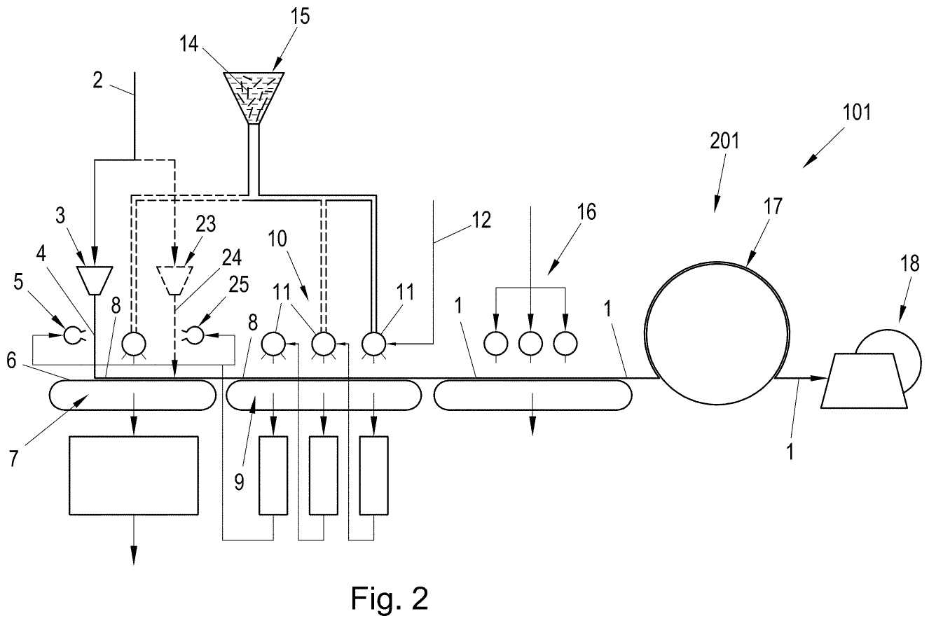

In FIG. 2, a second alternative embodiment variant of the process 101 according to the invention and, respectively, of the device 201 is illustrated. In this case, the suspension 15 with the short fibers 14 is not supplied to an independent wet-laying device 13, in contrast to the embodiment variant shown in FIG. 1. Rather, the short fibers 14 are supplied to the washing solution 12 of at least one washing stage 11, preferably the final washing stage 11, of the washing 10 in such a way that the spunbonded nonwoven 8 is simultaneously washed and charged with the short fibers 14 during the washing 10. With regard to further features, reference is made to the explanations concerning FIG. 1.

This represents the technically most simple and, in addition, also most economical embodiment variant of the invention, since only the washing 10 of an existing spunbond plant has to be converted in such a way that one or several of the existing washing stages 11, in addition to their original function of homogeneously distributing and applying the washing solution 12, also fulfill the function of charging the spunbonded nonwoven 8 with suspensions 15 of short fibers 14.

In this case, the suspension 15 contains short fibers 14 in a concentration range of between 0.01 wt.-% and 2.00 wt.-% and fibre lengths ranging from 0.5 mm to 20 mm. In a further embodiment variant, which is not illustrated in the figures, the short fibers 14 may also be mechanically fibrillated fibers or, respectively, pulp fibers, with a refiner being additionally required for the fibrillation of the short fibers.

The suspension 15 is preferably formed by suspending the short fibers 14 in fresh water. The suspension 15 is preferably applied to the spunbonded nonwoven 8 only in the area of the last two washing stages 11 in order to impair a shift in the concentration distribution of solvent in the washing solution across the entire washing 10 only to a minimum extent, thus avoiding additional technical requirements and rising operating costs in connection with the treatment or, respectively, concentration of the solvent-containing wash water in the best possible manner. In addition, by supplying the suspension 15 to the washing 10, the need for washing solution 12 in the washing 10 can be reduced to a corresponding degree.

In a further embodiment variant, which is illustrated with dashed lines in FIG. 2, downstream of the first spinneret 3, a second spinneret 23 can be provided, through which the spinning mass 2 is also extruded into filaments 24. In doing so, the filaments 24 are deposited on the conveying device 7 over the first spunbonded nonwoven 8 to form a second spunbonded nonwoven.

In this case, the suspension 15 containing short fibers 14 is applied to the first spunbonded nonwoven 8 between the first spinneret 3 and the second spinneret 23 in order to produce the layer of short fibers 14. The second spunbonded nonwoven is then deposited directly on the layer of short fibers 14 so that a multi-layered composite nonwoven fabric 1 with several cellulosic spunbonded nonwovens 8 and short fibers 14 is formed. Optionally—as described above—the composite nonwoven fabric 1 can, in this case, be charged additionally with short fibers 14 during the washing 10.

In a further embodiment variant, the multi-layered composite nonwoven fabric 1 is treated in the subsequent hydroentanglement 16 in such a way that the layer structure of alternating spunbonded nonwovens 8 and short fibers 14 can be made largely unrecognizable and thus an even more extensive mixing area is formed in the composite nonwoven fabric 1.

Accordingly, for all the aforementioned embodiments of the process 100, 101 according to the invention, significant savings in terms of the demand for energy and fresh water will arise, as compared to the prior art, since
a) a spunbonded nonwoven 8 that is already moist and has never been dried is used, rather than a substrate that has already been dried and is wetted again by adding the short fibers 14 in the form of a suspension 15,
b) the wet short fibers 14 that have been added introduce less water per unit mass of cellulose into the still moist nonwoven product than an equivalent amount of non-dried cellulosic spunbonded nonwoven,
c) the need for washing solution 12 in the washing 10 can be reduced by the amounts of water supplied as the suspension 15, and
d) the waste water from a hydroentanglement 16 can be used as fresh water for the washing 10 and, respectively, the production of the suspension 15.

In addition, in a further embodiment variant, the expenditure on equipment for the process 101 can be further simplified in that the hydroentanglement 16 already takes place on the conveyor belt 9 together with the washing 10. In doing so, the latter may additionally exhibit a three-dimensional embossed structure, which can be transferred to the spunbonded nonwoven by the water jet treatment.

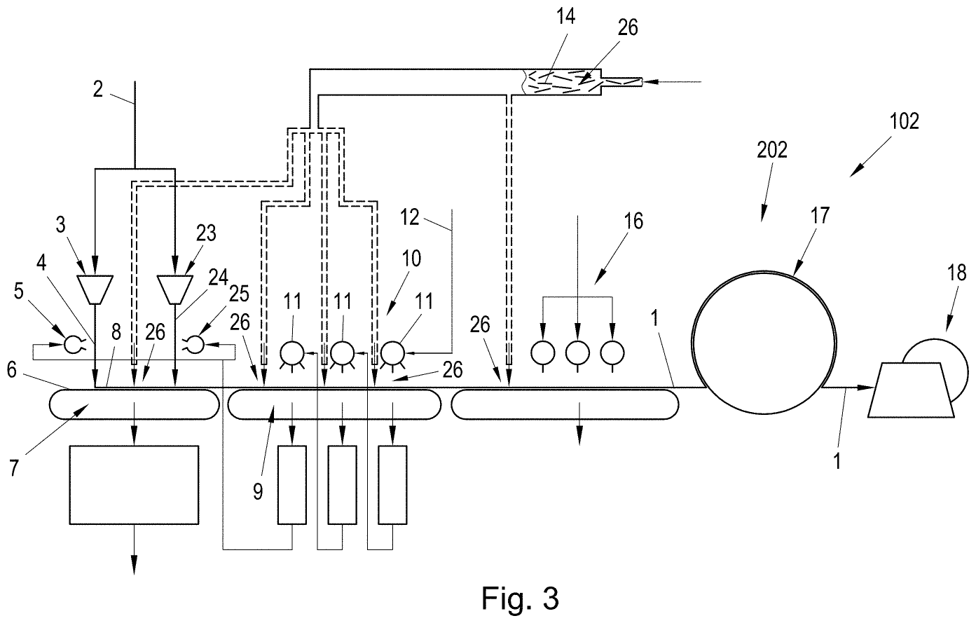

In FIG. 3, a third embodiment variant of the process 102 according to the invention and of the device 202 is illustrated. In contrast to the embodiment variants illustrated in FIGS. 1 and 2, the short fibers 14 are not applied to the spunbonded nonwoven 8 in the form of a suspension 15 in this case, but rather, they are applied to the spunbonded nonwoven 8 in the form of an air stream 26, using the airlaying technology. With regard to further features of the process 102, reference is made to the explanations concerning FIGS. 1 and 2.

The supply of the air stream 26 containing short fibers 14 to the spunbonded nonwoven 8 may take place between two spinnerets 3, 23 as well as before, within and/or after the washing 10.

In order to enable a homogeneous distribution of the short fibers 14 within the air stream 26 and to be able to convey the short fibers 14 to the place of application, special units for opening the fibers as well as for transporting the short fibers 14 are provided, which, however, have not been illustrated in further detail in the figures.

In a further embodiment variant, which is not illustrated in further detail in the figures, the short fibers 14 can also be supplied directly to the drawing devices in the spinnerets 3, 23 and thus can be pitched with the drawing air stream directly onto the filaments 4 of the spunbonded nonwoven 8. In doing so, the short fibers 14 are mixed directly with the filaments 4 in the spunbonded nonwoven, whereby a mixing area extending across the entire thickness of the composite nonwoven fabric 1 is created. For this purpose, in one embodiment variant, a secondary air stream, which comprises the short fibers 14, can, for example, be introduced below the spinnerets 3, 23, whereby it is merged with the drawing air stream in order to charge the filaments 4 with the short fibers 14.

In a further embodiment, which is not illustrated in the figures, a multi-layered spunbonded nonwoven 8 is produced by two spinnerets 3, 23 arranged one behind the other, however, it is unravelled into the two spunbonded nonwoven layers prior to the application of the short fibers 14, with the short fibers 14 subsequently being introduced between the two spunbonded nonwoven layers either as a suspension 15 or in a dry state within an air stream 26. Thereupon, the two spunbonded nonwoven layers are reconnected, and the obtained composite nonwoven fabric 1 is solidified in a hydroentanglement 16.

In order to be able to ensure full biodegradability of the composite nonwoven fabrics 1 according to the invention, the cellulosic short fibers introduced by means of the above-described embodiment variants exclusively consist of the types of substance of industrially produced pulps, pulps recovered from recycling processes, cellulosic short-cut fibers, cellulosic natural fibers or all possible combinations of those groups of substances.

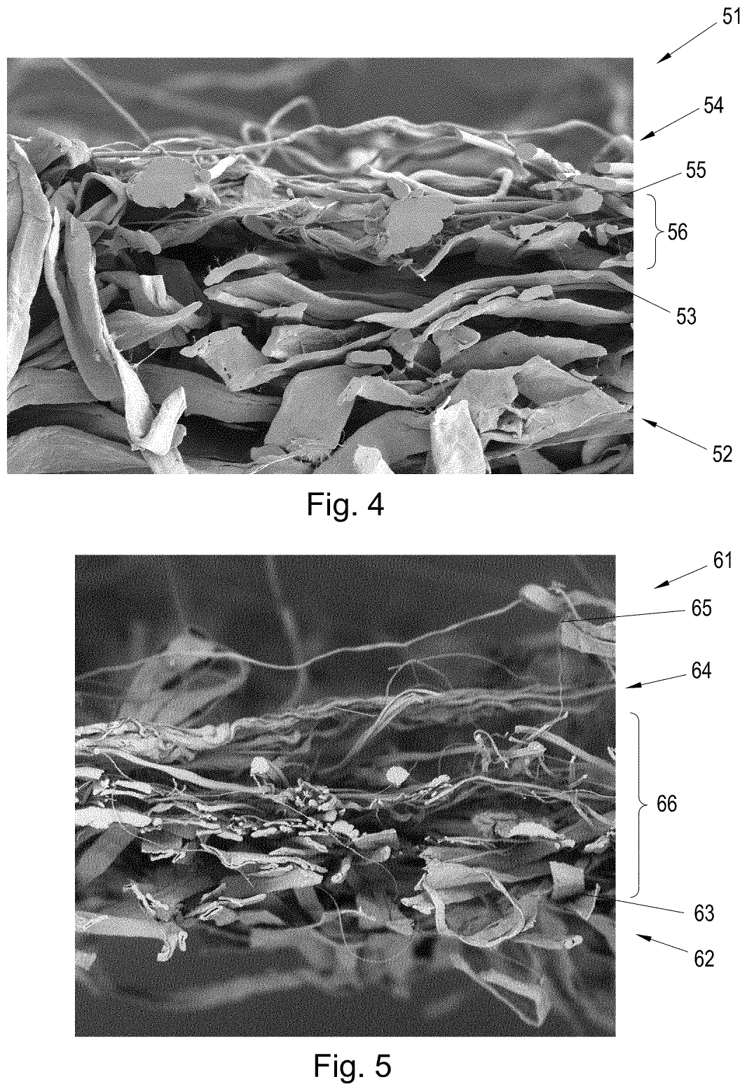

Electron microscope images of composite nonwoven fabrics 51, 61 produced according to the invention are shown in FIGS. 4 and 5.

FIG. 4 shows a composite nonwoven fabric 51 in which a limited mixing area 56 is formed between a layer 52 of short fibers 53 (pulp fibers in this case) and a cellulosic spunbonded nonwoven 54 (lyocell spunbonded nonwoven). In the mixing area 56, the filaments 55 of the spunbonded nonwoven 54 are physically mixed with the short fibers 53.

FIG. 5 shows a composite nonwoven fabric 61 which no longer has an identifiable layer structure. Here, the cellulosic spunbonded nonwoven 64 (lyocell spunbonded nonwoven) penetrates the layer 62 of short fibers 63 (pulp fibers) essentially completely. The mixing area 66 thus extends across the entire thickness of the composite nonwoven fabric 61. Thus, the short fibers 63 are distributed homogeneously across the composite nonwoven fabric 61.

### EXAMPLES

In the following, the advantages of the invention are exemplified using several examples.

The following measuring methods were used to determine various parameters of the produced composite nonwoven fabrics:

### Basis Weight

The basis weight indicates which mass the composite nonwoven fabric exhibits per unit area. The determination of the basis weight is done according to the NWSP 130.1.R0 standard (15).

### Tensile Strength/Elongation

The tensile strength values provide information about the robustness of the wipe in wiping operations or, respectively, during removal from the package. An increased tensile strength therefore results in a higher resistance to damage under tensile stress. A minor elongation is helpful when the wipes are removed from the package and helps to keep the wipe firmly in place in the wiping hand. The tensile strength and, respectively, the elongation are determined in accordance with DIN EN 29073 Part 3/ISO 9073-3 (version from 1992).

### Wicking

The rise height test (wicking) provides information about the distribution rate of a liquid or, respectively, lotion across the nonwoven surface in the machine and cross directions. The values indicated below refer to the rise heights of water in the nonwoven over a period of 300 s. The rise height is determined according to NWSP 010.1.R0 (15).

### Nonwoven Conditioning

Prior to each measurement, the samples were conditioned at 23° C. (±2° C.) and 50% (±5%) relative humidity over a period of 24 h.

### Electron Microscopy

The electron microscope images were obtained using a measuring device of the type ThermoFisher Quanta 450 (5 kV, Spot 3, WD10, EDT) or Thermo Fisher Scientific, Phenom ProX. The selection of sites was made at random.

The composite nonwoven fabrics described below were manufactured by the process according to the invention in such a way that single-ply lyocell spunbonded nonwovens with basis weights of 20-45 g/m² were produced and loaded with a 0.8-1.5% pulp suspension within the washing by means of an additionally installed wet-laying device. The composite nonwoven fabric was finally treated by hydroentanglement using three pressure stages (with pressures of between 40 bar and 100 bar), was dried to a final moisture content of less than 10% and was obtained in the form of rolled goods with basis weights of 30-80 g/m². The nozzle strips used in the hydroentanglement exhibited a single-row pattern of holes with hole diameters of 0.12 mm and a hole spacing of 13 holes/cm.

The detailed parameters of the tests carried out as well as the measured properties of the associated composite nonwoven fabrics are illustrated below in Table 1.

TABLE 1
Test parameters and product properties

| | Example | | | | |
|---|---|---|---|---|---|
| product | 1 | 2 | 3 | 4 | 5 |
| Basis weight of the substrate [g/m²] | 45 | 20 | 20 | 20 | 20 |
| Solids content of the suspension [%] | 0.5 | 0.7 | 0.8 | 1.0 | 1.2 |
| Hydroentanglement pressure p1 [bar] | 40 | 70 | 40 | 40 | 40 |
| Hydroentanglement pressure p2 [bar] | 40 | 80 | 40 | 40 | 40 |
| Hydroentanglement pressure p3 [bar] | 60 | 100 | 70 | 40 | 40 |
| Basis weight of the end product | 70 | 45 | 45 | 45 | 60 |
| [g/m²] | | | | | |
| Tensile strength (dry, MD) [N/5 cm] | 45 | 16 | 30 | 33 | 40 |
| Tensile strength (dry, CD) [N/5 cm] | 18 | 7 | 10 | 12 | 15 |
| Tensile strength (wet, MD) [N/5 cm] | 14 | 6 | 10 | 11 | 8 |
| Tensile strength (wet, CD) [N/5 cm] | 6 | 3 | 5 | 5 | 5 |
| Elongation (dry, MD) [%/5 cm] | 4 | 4 | 4 | 4 | 4 |
| Elongation (dry, CD) [%/5 cm] | 7 | 7 | 7 | 7 | 7 |
| Elongation (wet, MD) [%/5 cm] | 14 | 8 | 8 | 8 | 8 |
| Elongation (wet, CD) [%/5 cm] | 27 | 28 | 18 | 20 | 25 |
| Wicking MD [mm] | 146 | 161 | 149 | 150 | 152 |
| Wicking CD [mm] | 122 | 139 | 132 | 131 | 133 |

Concurrently with the indicated composite nonwoven fabrics produced according to the invention, a commercially available composite nonwoven fabric based on a polypropylene nonwoven substrate comprising an incorporated pulp with a total basis weight of 45 g/m² was examined in terms of its mechanical properties. With dry tensile strengths of 33 N/5 cm in the machine direction (MD) and of 13 N/5 cm in the cross direction (CD), the commercial product has dry strengths comparable to that of the exemplary product 4 listed in Table 1. The strength values provide information about the robustness of the wipe in wiping operations or, respectively, during removal from the package, with the indicated composite nonwoven fabrics according to the invention doing without the use of a synthetic carrier web. By contrast, exclusively wet-laid paper products of comparable basis weights exhibit lower wet tensile strengths of 4-8 N/5 cm, which, however, are hardly sufficient anymore for the normal usage as a wet wipe.

The aforementioned commercially available composite nonwoven fabric based on a polypropylene nonwoven substrate with an incorporated pulp with a total basis weight of 45 g/m² was examined also in terms of its liquid absorption capacity: According to the wicking test, significantly lower rise heights of 94 mm in MD and 73 mm in CD were measured, whereby the product according to the invention is given clear advantages in terms of its loading rate with lotions in conversion processes to produce commercial wet wipes, i.e., the dry rolled goods absorb the lotion significantly faster during the loading process, and the homogeneously distributed liquid inside the closed wipe packages displays the formation of a loading gradient much more slowly due to the weight-related lowering of the liquid.

1. A composite nonwoven fabric comprising;
at least one spunbonded nonwoven which exhibits essentially continuous regenerated cellulosic filaments deposited in a random orientation; and
at least one layer of biobased biodegradable short fibers,
wherein the composite nonwoven fabric has at least one mixing area in which the continuous regenerated cellulosic filaments of the at least one spunbonded nonwoven and the biobased biodegradable short fibers are present in a state of physical interconnection.

2. The A composite nonwoven fabric according to claim 1, wherein the biobased biodegradable short fibers are cellulosic short fibers and the composite nonwoven fabric in an absolutely dry state has a cellulose content of at least 93 wt.-%, optionally at least 95 wt.-%, or optionally at least 97 wt.-%.

3. The composite nonwoven fabric according to claim 1, wherein the composite nonwoven fabric comprises between 10 wt.-% and 99 wt.-%, optionally between 15 wt.-% and 95 wt.-%, or optionally between 20 wt.-% and 90 wt.-%, of the continuous regenerated cellulosic filaments of the at least one spunbonded nonwoven and between 1 wt.-% and 90 wt.-%, optionally between 5 wt.-% and 85 wt.-%, or optionally between 10 wt.-% and 80 wt.-%, of the biobased biodegradable short fibers.

4. The composite nonwoven fabric according to claim 1, wherein the composite non woven fabric is essentially free from binders that do not occur naturally in wood.

5. The composite nonwoven fabric according to claim 1, wherein the biobased biodegradable short fibers are selected from the group comprising: natural cellulose fibers, pulp fibers, Viscose, Modal, Cupro and Lyocell fibers, chemically modified cellulose fibers, recycled cellulosic fibers, starch fibers, and combinations thereof.

6. The composite nonwoven fabric according to claim 1, wherein the biobased biodegradable short fibers have a length of between 0.5 mm and 15 mm, optionally between 1 and 12 mm.

7. The composite nonwoven fabric according to claim 1, wherein the composite nonwoven fabric is obtainable by a process according to claim 8.

8. A process for producing a composite nonwoven fabric according to claim 1, comprising
extruding a spinning mass containing cellulose through a plurality of nozzle holes of at least one spinneret to form filaments, and
drawing the filaments, in each case, in an extrusion direction, wherein the filaments are deposited in a random orientation on a perforated conveying device to form a spunbonded nonwoven and wherein short fibers are added to the spunbonded non woven to form the composite non woven fabric, wherein the filaments of the spunbonded nonwoven are charged with the short fibers in a never-dried state.

9. The process according to claim 8, wherein the filaments of the spunbonded nonwoven are charged with a suspension of the short fibers in the never-dried state.

10. The process according to claim 9, wherein the suspension comprises between 0.01 wt.-% and 2.00 wt.-% of the short fibers.

11. The process according to claim 9, wherein the filaments of the spunbonded nonwoven are charged with the suspension during washing.

12. The process according to claim 9, wherein the filaments of the spunbonded nonwoven are charged with the suspension during formation of the spunbonded nonwoven.

13. The process according to claim 8, wherein the filaments of the spunbonded nonwoven are charged with an air stream comprising the short fibers in the never-dried state.

14. The process according to claim 13, wherein the filaments are charged with a drawing air stream for drawing and the short fibers are added to the drawing air stream in order to charge the filaments of the spunbonded nonwoven with the short fibers in the never-dried state.

15. The process according to claim 8, wherein after the filaments have been charged with the short fibers, the composite nonwoven fabric is subjected to at least one treatment step, the at least one treatment step being selected from the group comprising: hydroentanglement, water jet embossing, water jet perforation, washing, drying and combinations thereof.

16. The process according to claim 8, wherein the spinning mass is a solution of cellulose in a direct solvent, optionally a tertiary amine oxide.

17. The process according to claim 8, wherein, after extrusion from the at least one spinneret, the filaments are coagulated at least partly.
